(19) United States
(12) Patent Application Publication
(10) Pub. No.: US 2018/0106523 A1
(43) Pub. Date: Apr. 19, 2018

(54) REFRIGERATOR FOOD INVENTORY PRESERVATION

(71) Applicant: Haier US Appliance Solutions, Inc., Wilmington, DE (US)

(72) Inventors: John Keith Besore, Prospect, KY (US); Brent Alden Junge, Evansville, IN (US)

(21) Appl. No.: 15/294,881

(22) Filed: Oct. 17, 2016

(51) Int. Cl. F25D 11/02; G05B 19/042

(52) U.S. Cl. CPC F25D 11/02; G05B 19/0428; F25D 2400/361; F25D 2600/06; F25D 2500/06; G05B 2219/2654

(57) ABSTRACT

A refrigerator appliance includes a user interface, an environmental control system, a plurality of compartments disposed within the food storage chamber, each compartment of the plurality of compartments defining a food storage sub-chamber, at least one of the food storage sub-chambers having independently controlled environmental conditions, the independently controlled environmental conditions of the at least one food storage sub-chamber comprising temperature and humidity, at least one sensor associated with each food storage sub-chamber having independently controlled environmental conditions, and a controller in operative communication with the user interface, the environmental control system, and the at least one sensor, the controller operable to identify a food item, determine preferred environmental conditions for storage of the identified food item, and provide an indication of which of the food storage sub-chambers most closely matches the determined preferred storage conditions.

### FIELD OF THE INVENTION

The present subject matter relates generally to refrigerator appliances, and more particularly to systems and methods for tracking and preserving a food inventory in a refrigerator appliance.

### BACKGROUND OF THE INVENTION

Refrigerator appliances generally include a cabinet that defines a chilled chamber. A wide variety of food items may be stored within the chilled chamber. The low temperature of the chilled chamber relative to ambient atmosphere assists with increasing a shelf life of the food items stored within the chilled chamber.

However, various different food items may have differing storage requirements. For example, the optimal temperature, humidity and/or atmospheric composition for one food item may differ from that of another food item, e.g., a meat or dairy product may last longer at a temperature that would be too cold for some fruits or vegetables.

Also, it can be difficult to accurately monitor storage conditions for the various food items as compared to a safe storage threshold for the food item(s). For example, the shelf life of a food item is influenced by storage temperature and storage time. Yet, the temperature within the chilled chamber may fluctuate, such as when the refrigerator door is opened frequently or left open for an extended period of time, or in case of a power outage.

Accordingly, a refrigerator with features for increasing the storage shelf life of food items therein would be useful.

### BRIEF DESCRIPTION OF THE INVENTION

The present subject matter provides a refrigerator appliance and related methods. Additional aspects and advantages of the invention will be set forth in part in the following description, or may be apparent from the description, or may be learned through practice of the invention.

In a first exemplary embodiment, a refrigerator appliance is provided. The refrigerator appliance includes a cabinet defining a food storage chamber, a user interface, an environmental control system, a plurality of compartments disposed within the food storage chamber, each compartment of the plurality of compartments defining a food storage sub-chamber, at least one of the food storage sub-chambers having independently controlled environmental conditions, the independently controlled environmental conditions of the at least one food storage sub-chamber comprising temperature and humidity, at least one sensor associated with each food storage sub-chamber having independently controlled environmental conditions, and a controller in operative communication with the user interface, the environmental control system, and the at least one sensor, the controller operable to identify a food item, determine preferred environmental conditions for storage of the identified food item, and provide an indication of which of the food storage sub-chambers most closely matches the determined preferred storage conditions.

In a second exemplary embodiment, a method of tracking a food inventory in a refrigerator appliance is provided. The refrigerator appliance comprising a controller, a plurality of food storage sub-chambers, at least one of the food storage sub-chambers having independently controlled temperature and humidity, and at least one sensor associated with each food storage sub-chamber having independently controlled environmental conditions. The method includes identifying a food item with a scanner in operative communication with the controller, adding an entry associated with the food item to an inventory log stored in a memory of the refrigerator controller, retrieving food storage data related to the identified food item, the food storage data comprising preferred temperature and humidity for storage of the identified food item, and indicating with a user interface element of the refrigerator which of the food storage sub-chambers most closely matches the retrieved preferred temperature and humidity for storage of the identified food item.

In a third exemplary embodiment, a method of tracking and preserving a food inventory in a refrigerator appliance is provided. The refrigerator appliance comprising a controller, a plurality of food storage sub-chambers, at least one of the food storage sub-chambers having independently controlled environmental conditions, and at least one sensor associated with each food storage sub-chamber having independently controlled environmental conditions. The method includes identifying a food item with a scanner in operative communication with the controller, adding an entry associated with the food item to an inventory log stored in a memory of the refrigerator controller, retrieving food storage data related to the identified food item, the food storage data comprising preferred environmental conditions for storage of the identified food item and a safe storage threshold for the identified food item, recording the retrieved food storage data in the inventory log entry associated with the food item, monitoring the storage time of the food item, monitoring the storage temperature of the food item over time by monitoring temperature with one of the sensors, flagging the inventory log entry associated with the food item when the food item approaches the safe storage threshold, and notifying a user of the flagged food item.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to an exemplary embodiment of the present subject matter;

FIG. 2 provides a front view of the refrigerator appliance of FIG. 1 with the doors in an open position;

FIG. 3 is a schematic illustration providing an example of a refrigeration cycle as may be used with one or more embodiments of the present subject matter;

FIG. 4 provides a schematic view of a refrigerator appliance according to an exemplary embodiment of the present subject matter;

FIG. 5 provides a flow diagram of an exemplary method for operating a refrigerator appliance according to one or more embodiments of the present subject matter;

FIG. 6 provides a flow diagram of another exemplary method for operating a refrigerator appliance according to one or more embodiments of the present subject matter; and

FIG. 7 and FIG. 8 provide a flow diagram of yet another exemplary method for operating a refrigerator appliance according to one or more embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

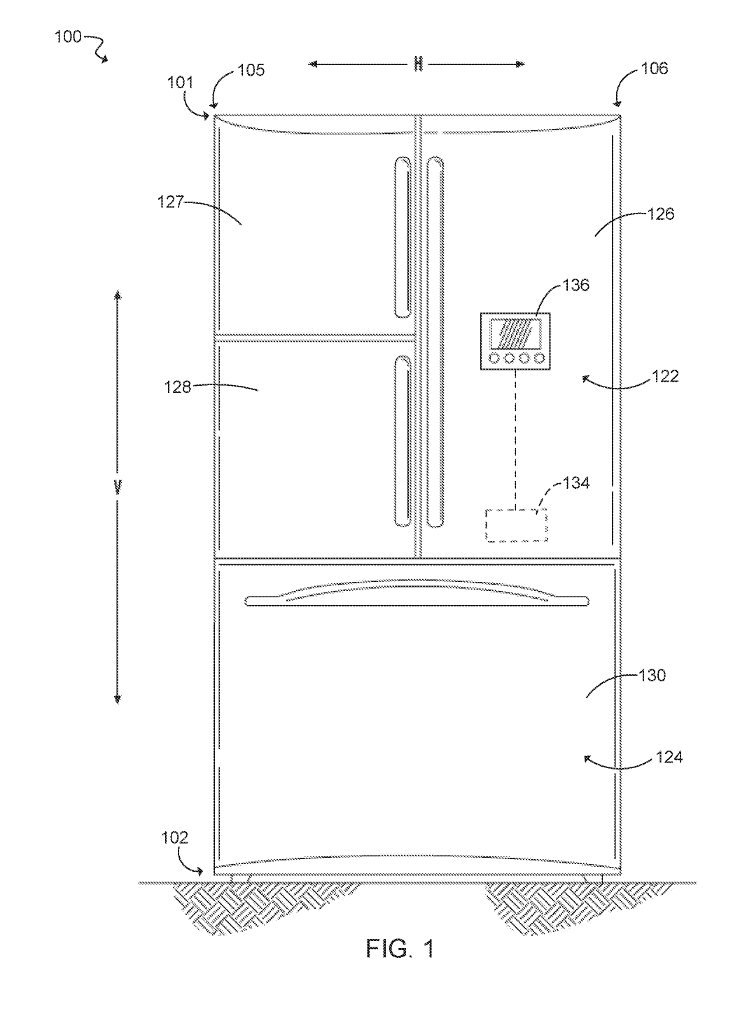

FIG. 1 is a front view of an exemplary embodiment of a refrigerator appliance 100. Refrigerator appliance 100 extends between a top 101 and a bottom 102 along a vertical direction V. Refrigerator appliance 100 also extends between a first side 105 and a second side 106 along a horizontal direction H.

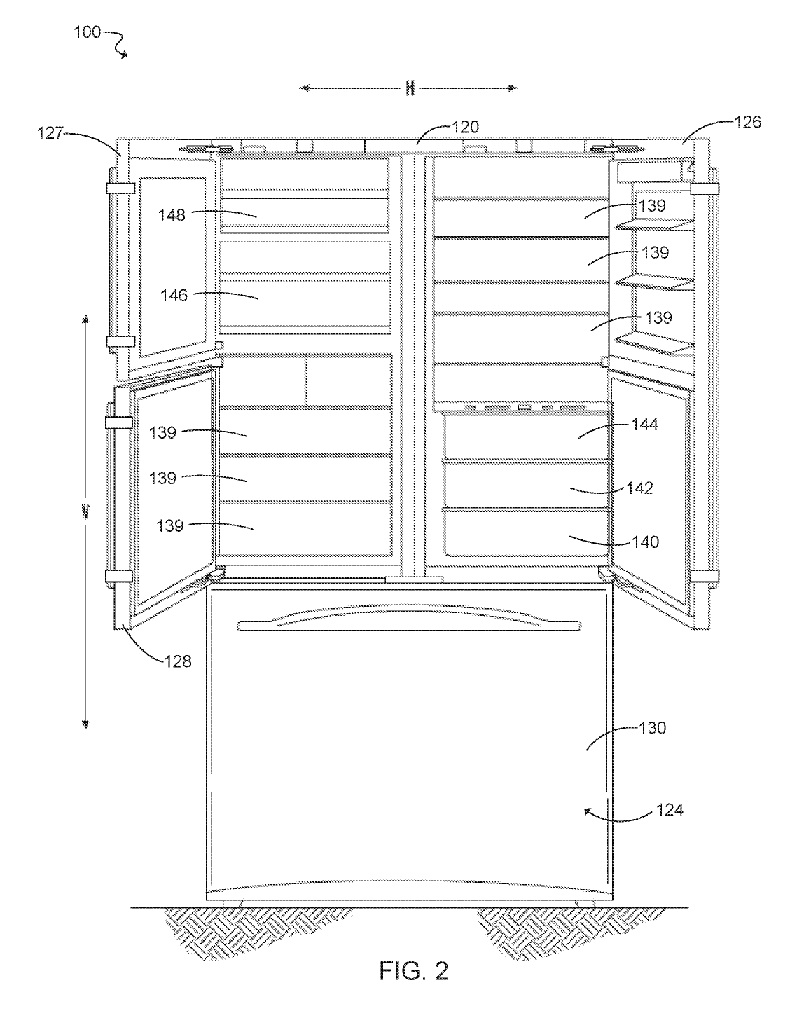

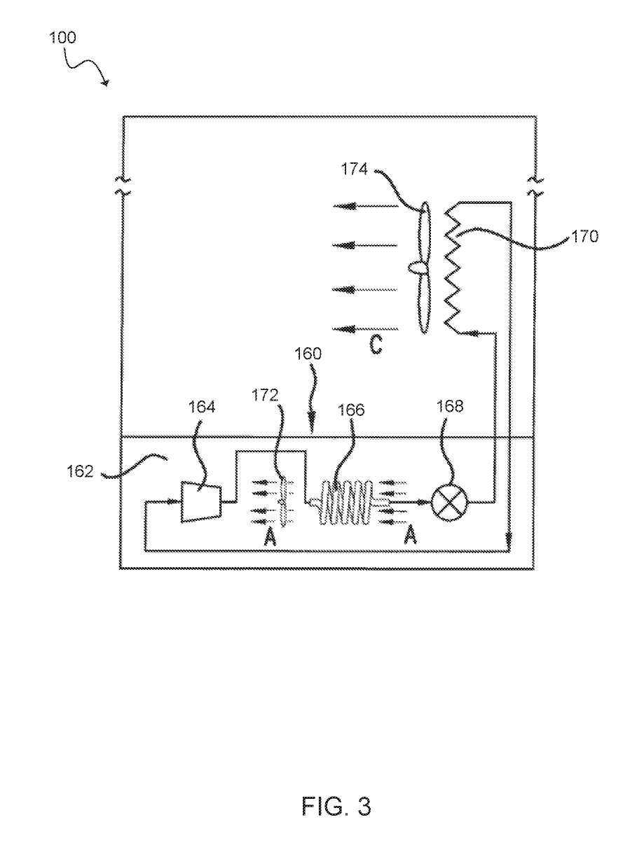

Refrigerator appliance 100 includes an insulated cabinet or housing 120 (FIG. 2) defining an upper fresh food chamber 122 and a lower freezer chamber 124 arranged below the fresh food storage chamber 122 along the vertical direction V. As such, refrigerator appliance 100 is generally referred to as a bottom mount refrigerator. In the exemplary embodiment, housing 120 also defines a mechanical compartment 162 (FIG. 3) for receipt of a sealed cooling system 160 (FIG. 3). Using the teachings disclosed herein, one of skill in the art will understand that the present subject matter can be used with other types of refrigerators such as a refrigerator/freezer combination, side-by-side, bottom mount, compact, and any other style or model of refrigerator appliance. Accordingly, other configurations of refrigerator appliance 100 could be provided, it being understood that the configurations shown in the accompanying FIGS. and the description set forth herein are by way of example for illustrative purposes only.

As seen in the exemplary embodiment illustrated in FIGS. 1 and 2, refrigerator doors 126, 127, and 128 are rotatably hinged to an edge of housing 120 for accessing fresh food chamber 122. It should be noted that while three doors 126, 127, and 128 in a “french door” configuration are illustrated, any suitable arrangement of doors utilizing one, two, or more doors is within the scope and spirit of the present disclosure. A freezer door 130 is arranged below refrigerator doors 126, 127, and 128 for accessing freezer chamber 124. In the exemplary embodiment, freezer door 130 is coupled to a freezer drawer (not shown) slidably coupled within freezer chamber 124.

FIG. 2 is a perspective view of refrigerator appliance 100 having refrigerator doors 126, 127, and 128 in an open position to reveal the interior of the fresh food chamber 122. A plurality of compartments are disposed within the food storage chamber, each compartment defining a food storage sub-chamber 139. In particular, at least one independently controlled food storage sub-chamber 140 is provided with independent environmental controls which permit the environmental conditions within sub-chamber 140 to differ from those of the fresh food chamber 122. The independently controlled food storage sub-chamber(s) 140, 142 may be sealed and provided with, e.g., separate insulation, separate ducting or conduits with associated dampers, valves, etc. for ventilation and/or directing cooling air or other gases into the sub-chamber(s) to modify environmental conditions within the sub-chamber independent of the fresh food chamber 122 and/or other sub-chambers. The present disclosure is not limited to any specific means or methods for achieving independent environmental control for each food storage sub-chamber.

In various embodiments, any number of food storage sub-chambers having independently controller environmental conditions may be provided. As illustrated in FIG. 2, a first food storage sub-chamber having independently controlled environmental conditions 140, a second food storage sub-chamber having independently controlled environmental conditions 142, a third food storage sub-chamber having independently controlled environmental conditions 144, a fourth food storage sub-chamber having independently controlled environmental conditions 146, and a fifth food storage sub-chamber having independently controlled environmental conditions 148 are defined within the fresh food chamber 122.

Operation of the refrigerator appliance 100 can be regulated by a controller 134 that is operatively coupled to a user interface 136. Interface 136 provides selections for user manipulation of the operation of refrigerator appliance 100 to modify environmental conditions therein, such as temperature selections, etc. Controller 134 may regulate operation of various components of the refrigerator appliance 100 in response to programming and/or user manipulation of the user interface 136. The controller may include one or more memory devices and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In some embodiments, the processor executes programming instructions stored in memory. The memory may be a separate component from the processor or may be included onboard within the processor. In some embodiments, a battery backup may be provided for controller 134 in the event of a power loss.

The controller 134 may be positioned in a variety of locations throughout refrigerator appliance 100. In the illustrated embodiment, the controller 134 may be located within the door 126. In such an embodiment, input/output (“I/O”) signals may be routed between the controller and various operational components of refrigerator appliance 100. Through user interface panel 136, a user may select various operational features and modes and monitor the operation of refrigerator appliance 10. In one embodiment, the user interface panel 136 may represent a general purpose I/O (“GPIO”) device or functional block. In some embodiments, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 134 via one or more signal lines or shared communication busses.

FIG. 3 is a schematic view of refrigerator 100 including an exemplary sealed cooling system 160. In accordance with known refrigerators, refrigerator 100 includes a machinery compartment 162 that at least partially contains components for executing a known vapor compression cycle for cooling air. The components include a compressor 164, a heat exchanger or condenser 166, an expansion device 168, and an evaporator 170 connected in series and charged with a refrigerant. Evaporator 170 is also a type of heat exchanger which transfers heat from air passing over the evaporator to a refrigerant flowing through evaporator 170 thereby causing the refrigerant to vaporize. As such, cooled air C is produced and configured to refrigerate compartments 122, 124 of refrigerator 100.

From evaporator 170, vaporized refrigerant flows to compressor 164, which operates to increase the pressure of the refrigerant. This compression of the refrigerant raises its temperature, which is lowered by passing the gaseous refrigerant through condenser 166 where heat exchange with ambient air takes place so as to cool the refrigerant. A fan 172 is used to pull air across condenser 166, as illustrated by arrows A, so as to provide forced convection for a more rapid and efficient heat exchange between the refrigerant and the ambient air.

Expansion device 168 further reduces the pressure of refrigerant leaving condenser 166 before being fed as a liquid to evaporator 170. Collectively, the vapor compression cycle components in a refrigeration circuit, associated fans, and associated compartments are sometimes referred to as a sealed refrigeration system operable to force cold air through refrigeration compartments 122, 124. The refrigeration system depicted in FIG. 3 is provided by way of example only. It is within the scope of the present invention for other configurations of the refrigeration system to be used as well. For example, fan 174 may be repositioned so as to push air across evaporator 170, dual evaporators may be used with one or more fans, and numerous other configurations may be applied as well.

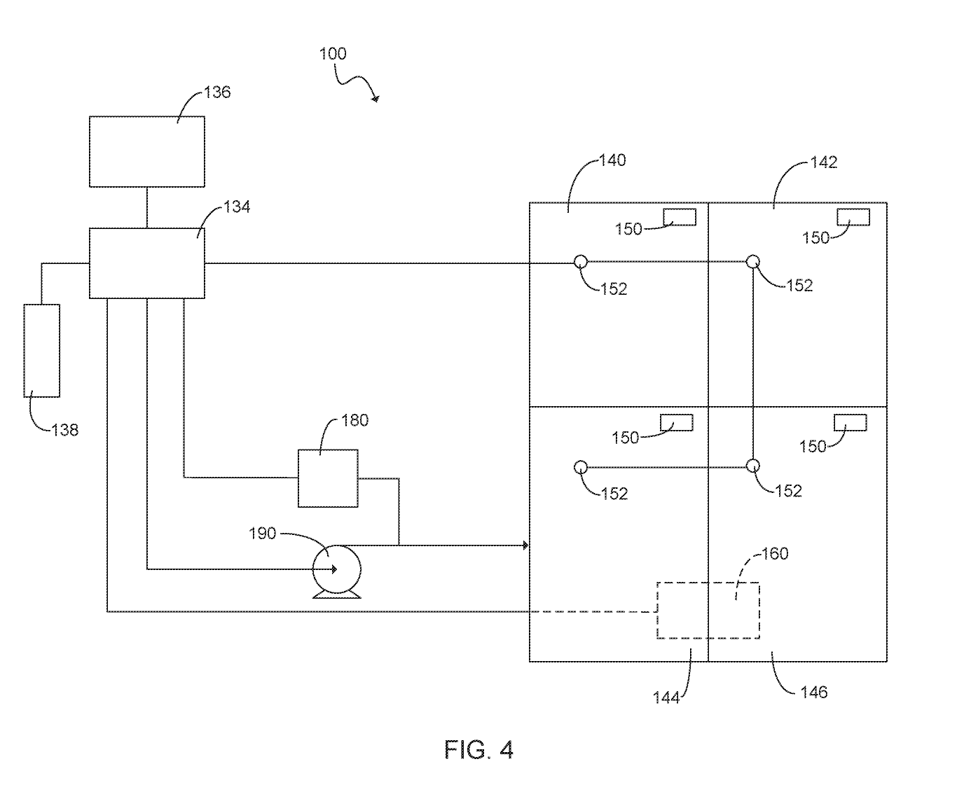

FIG. 4 is a schematic view of an exemplary refrigerator appliance 100 with four food storage sub-chambers having independently controlled environmental conditions 140, 142, 144, and 146. The independently controlled environmental conditions of each food storage sub-chamber may include but are not limited to temperature, humidity, and/or atmospheric composition. The environmental control system includes sealed cooling system 160 for controlling temperature, and may further include a humidity control device 190 and one or more atmospheric composition control devices 180. Possible humidity control devices may include a mist pump 190 or a membrane micro-humidifier cell to add or extract moisture as required. Atmospheric composition within one or more sub-chambers may be controlled or modified by devices such as ozone generator 180, which may be a Coplanar Discharge Ozone Generator (CDOG), for adding ozone, a UV light, and/or a vent, filter, or adsorbent for removing ethylene. Ozonation or UV light may be useful in some environmental conditions, e.g., when humidity is increased, for suppressing mold growth. Ethylene is produced by some fruits as they ripen and high atmospheric concentrations of ethylene may accelerate the ripening of the fruit, as such, removing or reducing ethylene from food storage sub-chambers containing fruits may prolong the shelf life of the stored fruit. Each food storage sub-chamber may be provided with independent ducts and associated dampers for selectively providing the necessary amount of cooled air C (FIG. 3) to each food storage sub-chamber to achieve the preferred temperature for storage of various food items, as well as to provide preferred ventilation. Mist pump 190 and/or ozone generator 180 or other equipment for modifying the environmental conditions of one or more of the food storage sub-chambers may be in fluid communication with each food storage sub-chamber or a selected subgroup of the sub-chambers. For example, in an embodiment including three independently controlled food storage sub-chambers, all three sub-chambers may each have a separate fluid conduit connected thereto for providing, e.g., mist from mist pump 190 to control the humidity in each sub-chamber. It is also possible in other embodiments including three independently controlled food storage sub-chambers to provide humidity control in only one or two of the sub-chambers, while the remaining food storage sub-chambers having independently controlled environmental conditions may have, e.g., independently controlled temperature. In various other embodiments, certain features, e.g., humidity control or ethylene level control, may be provided in all or less than all of the food storage sub-chambers having independently controlled environmental conditions.

The exemplary refrigerator appliance 100 of FIG. 4 may further include at least one sensor 152 associated with each food storage sub-chamber having independently controlled environmental conditions, each sensor in operative communication with the controller 134. The at least one sensor 152 may be configured to sense one or more environmental conditions within the corresponding food storage sub-chamber. The controller 134 may also be in operative communication with the environmental control system such that the controller may receive a signal from the sensors indicative of a sensed environmental condition such as temperature within the food storage sub-chambers and the controller 134 may then operate the environmental control system in response to the received signal in order to modify the temperature, humidity, and atmospheric composition of one of the plurality of food storage sub-chambers to approximate the preferred temperature, humidity, and atmospheric composition for storage of the identified food item.

In some embodiments, e.g., as shown in FIG. 4, the refrigerator appliance 100 may be configured for identifying a food item. In some embodiments, the food item may be identified in response to a manual entry via user interface 136. In some embodiments, controller 134 may be programmed to recognize a shorthand for entering identifying information for a food item, e.g., the controller 134 may use predictive text to recognize an entry of “T” or “TO” as identifying tomatoes. In some embodiments, identification of the food item may be accomplished with a scanner 138 in operative communication with the controller 134. In various exemplary embodiments, the scanner 138 may be coupled to the controller 134 via a wired or wireless communication connection or interface. In some embodiments, the scanner 138 may be physically connected to the refrigerator appliance 100. For example, the scanner 138 may be integrated into the refrigerator 100, such as a bar code scanner built in to the refrigerator door 126 for scanning UPC codes and/or QR codes. As another example, the scanner 138 could be a hand-held device connected to the refrigerator with a flexible, extendable cord or wire. In other embodiments, the scanner 138 may communicate remotely with the refrigerator device. For example, the scanner may be a hand-held device in operative communication with the controller via a wireless connection. For purposes of the description herein, wireless communication connections and interfaces can include, but are not limited to, wireless radio (e.g., FM/AM), WI-FI®, BLUETOOTH®, ZIGBEE® laser, infrared, and Ethernet wireless type devices and interfaces. In various embodiments where the scanner is provided as a hand-held device, the hand-held device may be a specialized, single-purpose device such as a bar code scanner gun, or may be a multipurpose device such as a cell phone or smart phone or any similar device which is capable of scanning, e.g., a one-dimensional or two-dimensional bar code associated with the food item in order to transmit food identification information encoded therein to the controller 134. The scanner 138 may be provided in various forms, for example, the scanner 138 may also be a countertop unit or wall-mounted unit in operative communication with the controller 134 via either a wired or wireless connection.

In various embodiments, the scanner 138 may be a visual scanner in communication with controller 134. In such embodiments, controller 134 may be configured for image-based processing, e.g., to identify a food item. For example, scanner 138 may be a visual scanner for reading two-dimensional bar codes such as QR codes which are then decodes by controller 134. As another example, scanner 138 may be a visual scanner and the controller 134 may be configured to identify the food item by comparison to a stored image of a known or previously-identified food item. Providing a visual scanner 138 may permit more detailed identification of the scanned food item, such as identifying the size, shape, and/or volume of the food item. Such detailed identification may permit, for example, a determination of which food storage sub-chamber(s) has or have sufficient available space for storing the identified item.

Features illustrated or described as part of one embodiment may be combined with another embodiment to arrive at yet another embodiment. For example, some embodiments may include manual entry of food item identification via user interface 136 in combination with a visual scanner 138. In such embodiments, the controller may be configured to learn food items that were manually entered so subsequent food items of the same type could be visually identified using scanner 138 without manually entering the identification information.

The refrigerator appliance 100 and in particular, controller 134 thereof, may be operable to determine preferred environmental conditions for storage of the identified food item. Such determination may be based on retrieving food storage data related to the identified food item. The retrieved food storage data may include preferred environmental conditions for storage of the identified food item and a safe storage threshold for the identified food item. The food storage data may be stored in and retrieved from a memory of the refrigerator controller 134, or may be retrieved from a remote location. For example, the food storage data may be retrieved via a network. Some embodiments may include retrieving at least one recipe from a recipe database, as will be discussed in further detail hereinbelow. The recipe database may be stored in an onboard memory or remotely, in a similar manner as the food storage data.

The refrigerator appliance 100 may also be configured for indicating which of the food storage sub-chambers most closely matches the retrieved preferred environmental conditions for storage of the identified food item. In some embodiments, indicating which of the food storage sub-chambers most closely matches the retrieved preferred environmental conditions may include indicating with a user interface element of the refrigerator. In some embodiments, the preferred environmental conditions for storage of the identified food item may include temperature, humidity, and atmospheric composition. In some embodiments, the user interface element may be provided as a separate indicator 150 (FIG. 4) in association with each food storage sub-chamber. In some embodiments, the indicator 150 may be, e.g., a visual indicator such as an LED light. In some embodiments, an audible indicator may be provided instead of or in addition to a visual indicator. In embodiments wherein a visual indication is provided, the visual indication may comprise a light that blinks, a light that changes color, or any other suitable visual indication. In some embodiments, the user interface element may be a display component of user interface 136. For example, the independently controlled food storage sub-chambers 140, 142, 144, 146, and 148 may each be visually identified with an alphanumeric designation, such as “A,” “B,” etc., or “1,” “2,” etc., or any other suitable identifier, and in some such embodiments, the step of indicating with a user interface element of the refrigerator may comprise displaying on the display component of user interface 136 the alphanumeric designation corresponding to the food storage sub-chamber which most closely matches the retrieved preferred temperature, humidity, and atmospheric composition for storage of the identified food item.

It should be noted that controllers 134 as disclosed herein are capable of and may be operable to perform any methods and associated method steps as disclosed herein.

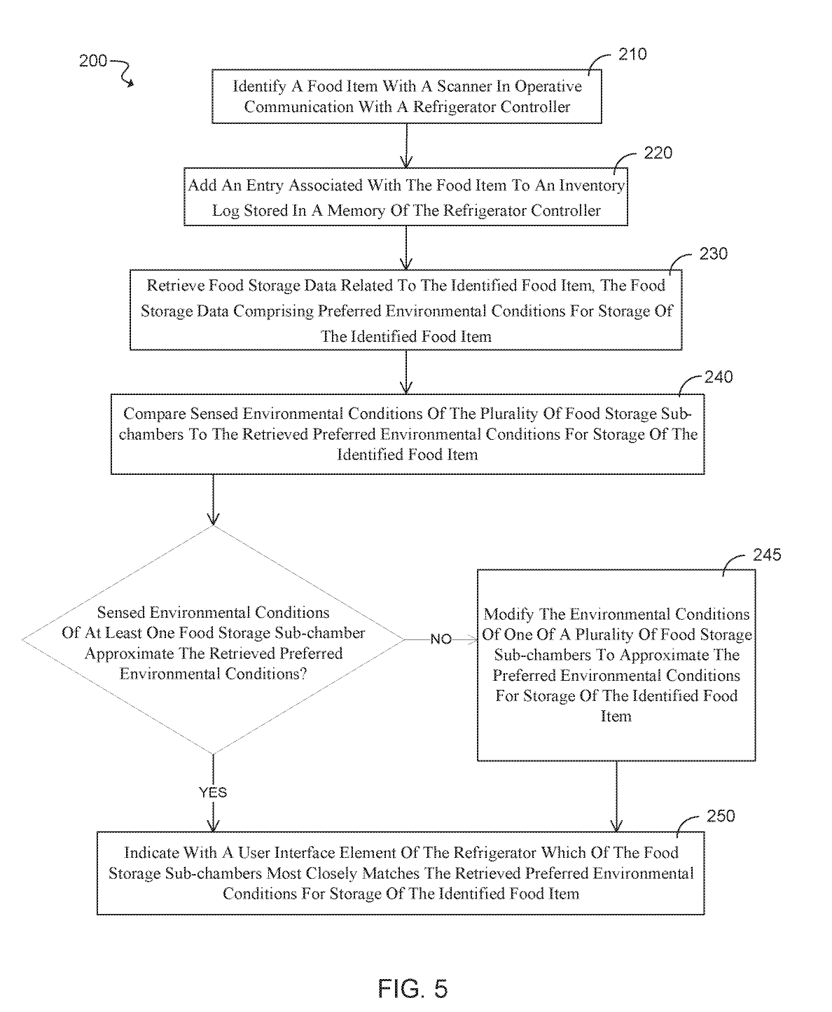

For example, referring to FIG. 5, an exemplary method 200 for tracking a food inventory in a refrigerator appliance 100 according to at least one embodiment is illustrated. The refrigerator appliance 100 may include a controller, a plurality of food storage sub-chambers, at least one of the food storage sub-chambers having independently controlled environmental conditions, and at least one sensor associated with each food storage sub-chamber having independently controlled environmental conditions. The independently controlled environmental conditions may include temperature, humidity, and/or atmospheric composition,

In some embodiments, method 200 may include the step 210 of identifying a food item with a scanner 138 in operative communication with the controller 134. For example, as discussed above, a scanner 138 may be integrated into the refrigerator appliance 100 or separately formed with a wireless or wired connection therebetween.

The exemplary method 200 may further include a step 220 of adding an entry associated with the food item to an inventory log stored in a computer memory. In some exemplary embodiments, the computer memory may be a memory onboard the refrigerator controller 134. In some exemplary embodiments, the computer memory may be remotely located and accessed by the controller 134 via a network. The inventory log may comprise various items of information regarding the identified food item. For example, storage time, storage location, preferred storage conditions, and safe storage threshold(s), among other such data, may be included in the entry associated with the identified food item in the stored inventory log according to various exemplary embodiments. Additionally, the inventory log may be updated, e.g., by scanning food items with scanner 138 again when the items are removed from the refrigerator 100, in which case the entry associated with the food item may be deleted from the inventory log. In such embodiments, e.g., when the removed food item is the last food item in the food storage sub-chamber from which the item was removed, the food storage sub-chamber may then be made available for other food items, e.g., by modifying environmental conditions, as discussed herein. In another example, when the environmental conditions in the food storage sub-chamber are set to accommodate multiple food items with varying preferred environmental conditions, the environmental conditions of the food storage sub-chamber may be set at a compromise or intermediate value in order to most closely match more than one set of preferred storage conditions. Thus, when a food item is removed from the food storage sub-chamber, the environmental conditions within may be modified to more closely match the preferred storage conditions of the remaining items in the food storage sub-chamber.

The exemplary method 200 may further include a step 230 of retrieving food storage data related to the identified food item. In some embodiments, the food storage data may include preferred environmental conditions for storage of the identified food item. The food storage data may be retrieved from a memory onboard the refrigerator controller 134 in some embodiments, while other embodiments may include retrieving food storage data related to the identified food item from a remote location, such as via a network.

The exemplary method 200 may further include a step 240 of comparing sensed environmental conditions of the plurality of food storage sub-chambers to the retrieved preferred environmental conditions for storage of the identified food item to determine whether to modify the environmental conditions of one of the plurality of food storage sub-chambers to approximate the preferred environmental conditions for storage of the identified food item.

The exemplary method 200 may further include a step 245 of modifying the environmental conditions of one of the plurality of food storage sub-chambers to approximate the preferred environmental conditions for storage of the identified food item.

The exemplary method 200 may further include a step 250 of indicating with a user interface element of the refrigerator which of the food storage sub-chambers most closely matches the preferred environmental conditions for the identified food item. For example, the step 250 may include indicating the food storage sub-chamber which most closely matches the retrieved preferred temperature, humidity, and/or atmospheric composition for storage of the identified food item. In some instances, it may be determined in the comparing step 240 that a food storage sub-chamber approximating the preferred environmental conditions for storage of the food item is already available, i.e., in such cases, the modifying step 245 may not be necessary. In other embodiments, the step 250 of indicating with a user interface element of the refrigerator which of the food storage sub-chambers most closely matches the retrieved preferred environmental conditions for storage of the identified food item may include indicating the modified food storage sub-chamber, i.e., the food storage sub-chamber wherein the environmental conditions were modified in step 245.

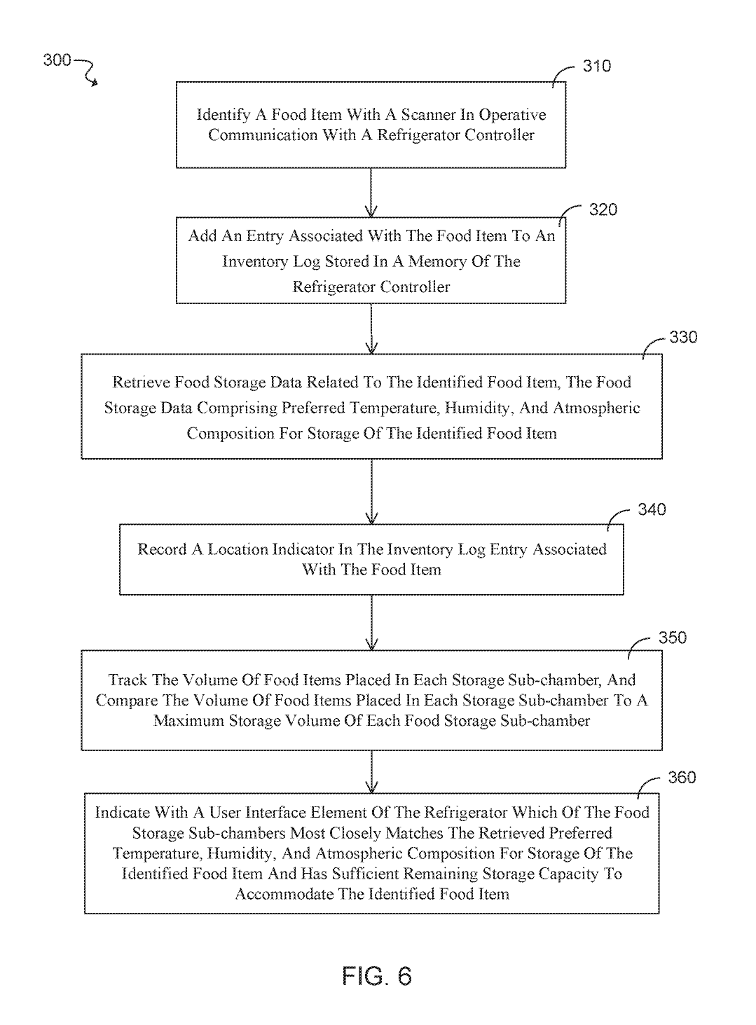

As another example, FIG. 6 illustrates an exemplary method 300 for tracking a food inventory in a refrigerator appliance 100 according to at least one embodiment of the present disclosure. The refrigerator appliance 100 may include a controller, a plurality of food storage sub-chambers, at least one of the food storage sub-chambers having independently controlled temperature, humidity, and atmospheric composition, and at least one sensor associated with each food storage sub-chamber having independently controlled temperature, humidity, and atmospheric composition.

In some embodiments, method 300 may include the step 310 of identifying a food item with a scanner 138 in operative communication with the controller 134. For example, as discussed above, a scanner 138 may be integrated into the refrigerator appliance 100 or separately formed with a wireless or wired connection therebetween.

The exemplary method 300 may further include a step 320 of adding an entry associated with the food item to an inventory log stored in a memory of the refrigerator controller 134.

The exemplary method 300 may further include a step 330 of retrieving food storage data related to the identified food item. In some embodiments, the food storage data may include an preferred temperature, humidity, and atmospheric composition for storage of the identified food item. The food storage data may be retrieved from a memory of the refrigerator controller 134 in some embodiments, while other embodiments may include retrieving food storage data related to the identified food item from a remote location, such as via a network.

The exemplary method 300 may further include a step 340 of recording a location indicator in the inventory log entry associated with the food item.

The exemplary method 300 may further include a step 350 of tracking the total volume of food items stored in each storage sub-chamber, and comparing the volume of food items placed in each storage sub-chamber to a maximum storage volume of each food storage sub-chamber. In such embodiments, the step 330 of retrieving food storage data related to the identified food item may further include retrieving a volume of the identified food item. In other embodiments, when scanner 138 is a visual scanner, the controller 134 may be configured to estimate the volume of the identified food item based on image recognition. Tracking the volume of food items placed in each storage sub-chamber may deducting the volume of each food item that is removed from the food storage sub-chamber from the tracked total stored volume. For example, the method 300 may include scanning each food item with scanner 138 a subsequent time when it is removed from the refrigerator 100 and then deducting the volume of that food item.

The exemplary method 300 may further include a step 360 of indicating which of the food storage sub-chambers most closely matches the retrieved preferred temperature, humidity, and atmospheric composition and has sufficient remaining storage capacity to accommodate the identified food item. For example, if a user buys a copious amount of meat and dairy products but relatively little produce, a first food storage sub-chamber having independently controlled environmental conditions may have suitable environmental conditions for storing meat and dairy but lack available storage capacity, while a second food storage sub-chamber having independently controlled environmental conditions may have available storage capacity but lack suitable environmental conditions for storing meat and dairy. In such cases, environmental conditions in the second food storage sub-chamber having independently controlled environmental conditions may be modified to more closely approximate the preferred environmental conditions for storing meat and/or dairy and the second food storage sub-chamber having independently controlled environmental conditions may be indicated.

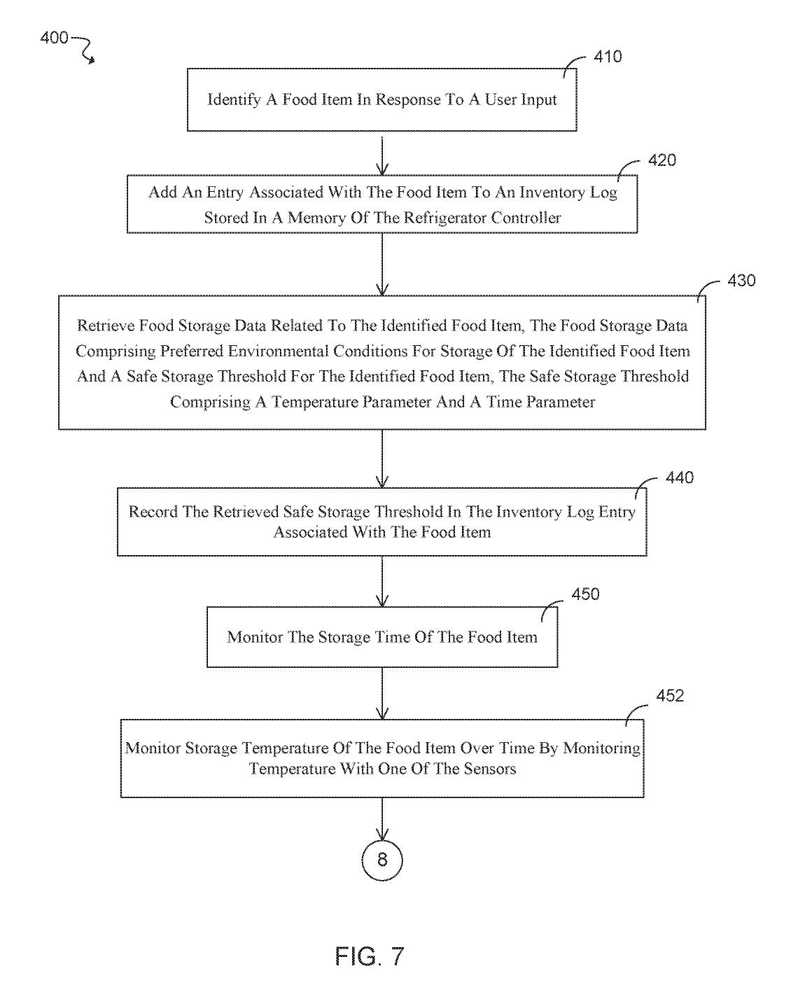

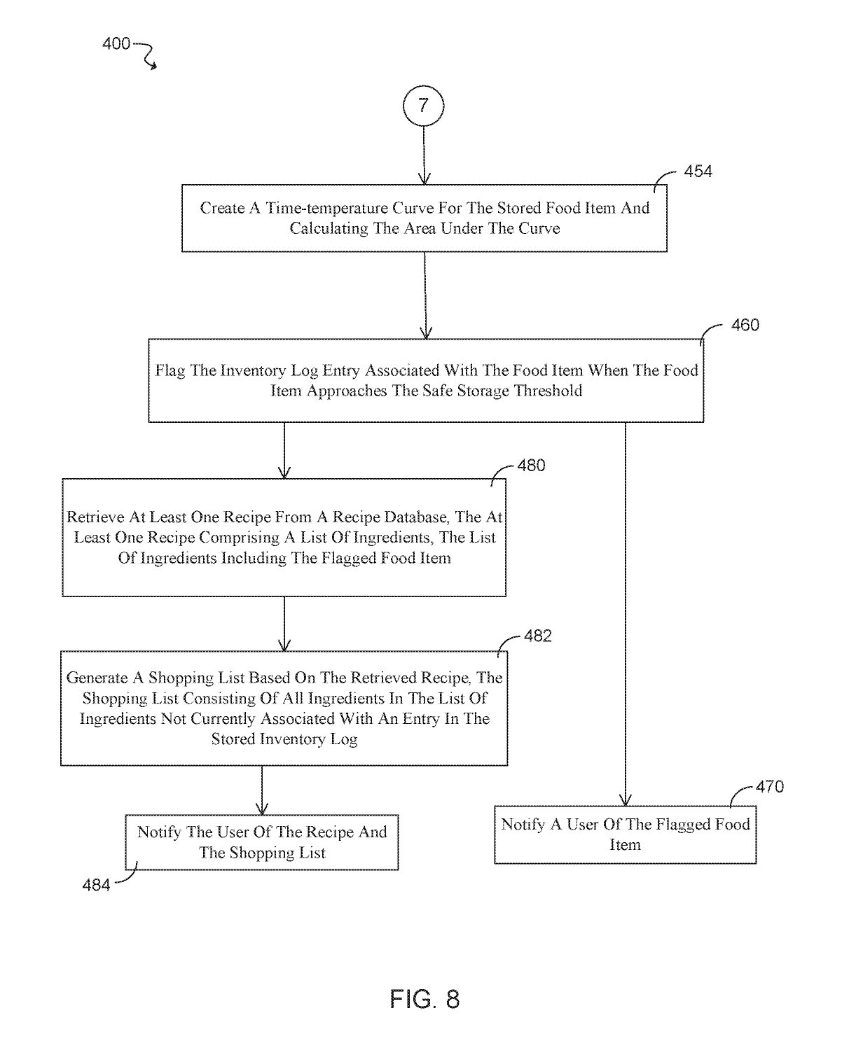

Referring now to FIGS. 7 and 8, method 400 of tracking and preserving a food inventory in a refrigerator appliance 100 in accordance with one or more embodiments of the present disclosure are provided. The steps of such methods may be utilized in addition to or separate from the steps of methods 200 and 300 discussed above in accordance with FIGS. 5 and 6, respectively. The refrigerator appliance 100 may include a controller, a plurality of food storage sub-chambers, at least one of the food storage sub-chambers having independently controlled environmental conditions, and at least one sensor associated with each food storage sub-chamber having independently controlled environmental conditions.

The method 400 may include the step 410 of identifying a food item in response to a user input. In some embodiments, the user input may be provided via a scanner in operative communication with the controller, in a similar manner as discussed hereinabove, e.g., with respect to method 200 and method 300. In some embodiments, the user input may be manually entered, e.g., via user interface 136.

The method 400 may include the step 420 of adding an entry associated with the food item to an inventory log stored in a memory of the refrigerator controller, in a similar manner as discussed hereinabove, e.g., with respect to method 200 and method 300.

The method 400 may include the step 430 of retrieving food storage data related to the identified food item. The food storage data may comprise preferred environmental conditions for storage of the identified food item and a safe storage threshold for the identified food item. The retrieved safe storage threshold for the identified food item may comprise a temperature parameter and a time parameter. The temperature parameter and time parameter of the safe storage threshold may be multiplied to arrive at a safe storage threshold defined in units of temperature times time. For example, in some embodiments, the safe storage threshold may include a maximum temperature and a corresponding maximum storage time at the maximum temperature, e.g., a particular food item may have a safe storage threshold defined in terms of a maximum number of hours at a given temperature. In some embodiments, the safe storage threshold temperature parameter and time parameter may be defined by ranges of values, e.g., a minimum temperature, a maximum temperature and a maximum time.

The method 400 may include the step 440 of recording the retrieved safe storage threshold in the inventory log entry associated with the food item.

The method 400 may include the step 450 of monitoring storage time of the food item. Monitoring the storage time of the food item may include adding a time stamp to the entry associated with the food item to an inventory log stored in a memory of the refrigerator controller. In addition to monitoring storage time, method 400 may include a step 452 of monitoring storage temperature of the food item over time. The storage temperature may be monitored by monitoring temperature with one of the sensors 152. Thus, in some embodiments the exemplary method 400 may include a step 454 of creating a time-temperature curve for the stored food item based on the monitored storage time and the monitored storage temperature, and calculating the area under the time-temperature curve. The area under the time-temperature curve may then be compared to a safe storage threshold when the safe storage threshold is defined in units of temperature times time. The area under the time-temperature curve may be calculated by any suitable method, such as integration or Riemann sum. In other embodiments, method 400 may include determining an average value of the monitored storage temperature of the food item over time.

The method 400 may include the step 460 of flagging the inventory log entry associated with the food item when the food item approaches the safe storage threshold. In some embodiments, flagging the inventory log entry associated with the food item when the food item approaches the safe storage threshold comprises flagging the inventory log entry associated with the food item when the area under the time-temperature curve approaches the product of the safe storage threshold temperature parameter and the safe storage threshold time parameter.

The method 400 may include the step 470 of notifying a user of the flagged food item. Such notification may, in some exemplary embodiments, be provided via a display of user interface 136. In other embodiments, the notification may be provided via a separate hand-held device such as a cell phone or smart phone. In exemplary embodiments wherein the hand-held device is a standard cell phone or a smart phone, the notification may be provided via SMS message. In exemplary embodiments wherein the hand-held device is a smart phone, the notification may be provided via an application.

The method 400 may include the step 480 of retrieving at least one recipe from a recipe database, the at least one recipe comprising a list of ingredients, the list of ingredients including the flagged food item. The method 400 may further include a step 482 of generating a shopping list based on the retrieved recipe, the shopping list consisting of all ingredients in the list of ingredients not currently associated with an entry in the stored inventory log. In some embodiments, the shopping list may include less than all ingredients in the list of ingredients not currently associated with an entry in the stored inventory log, e.g., some ingredients that are not normally stored in a refrigerator, such as dry goods, e.g., rice, pasta, flour, may be on the list of ingredients but not included in the shopping list. The method 400 may further include a step 484 of notifying the user of the recipe and the shopping list. In some embodiments, the notification of step 470 may be combined or simultaneous with the notifications of step 484. In other embodiments, the notification of step 470 may be provided separately and at a separate time from the notifications of step 484.

In some embodiments, method 400 may further include steps of modifying the environmental conditions of one of the plurality of food storage sub-chambers to approximate the retrieved preferred environmental conditions for storage of the identified food item, and indicating with a user interface element which of the food storage sub-chambers most closely matches the retrieved preferred environmental conditions for storage of the identified food item, in a similar manner as discussed hereinabove, e.g., with respect to steps 240 and/or 250 of method 200.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, comprising:
a cabinet defining a food storage chamber;
a user interface;
an environmental control system;
a plurality of compartments disposed within the food storage chamber, each compartment of the plurality of compartments defining a food storage sub-chamber;
at least one of the food storage sub-chambers having independently controlled environmental conditions, the independently controlled environmental conditions of the at least one food storage sub-chamber comprising temperature, humidity, and atmospheric ethylene level;
at least one sensor associated with each food storage sub-chamber having independently controlled environmental conditions; and
a controller in operative communication with the user interface, the environmental control system, and the at least one sensor, the controller operable to identify a food item, determine preferred environmental conditions for storage of the identified food item, and provide an indication of which of the food storage sub-chambers most closely matches the determined preferred storage conditions, wherein the indication comprises an alphanumeric designation corresponding to the food storage sub-chamber which most closely matches the determined preferred storage conditions.

2. The refrigerator appliance of claim 1, wherein the at least one sensor associated with each food storage sub-chamber having independently controlled environmental conditions senses temperature and humidity in each food storage sub-chamber having independently controlled environmental conditions.

3. The refrigerator appliance of claim 1, further comprising a scanner for identifying food items, wherein the controller is in operative communication with the scanner to identify a food item by receiving a scan from the scanner

4. The refrigerator appliance of claim 1, wherein the controller is further operable to modify environmental conditions of the at least one food storage sub-chambers having independently controlled environmental conditions to approximate the determined preferred environmental conditions for storage of the identified food item.

5. (canceled)

6. A method of tracking a food inventory in a refrigerator appliance, the refrigerator appliance comprising a controller, a plurality of food storage sub-chambers, at least one of the food storage sub-chambers having independently controlled temperature, humidity, and atmospheric ethylene level independently controlled by an environmental control system of the refrigerator appliance, and at least one sensor associated with each food storage sub-chamber having independently controlled temperature, humidity, and atmospheric ethylene level, the method comprising:
identifying a food item with a scanner in operative communication with the controller;
adding an entry associated with the food item to an inventory log stored in a computer memory;
retrieving food storage data related to the identified food item, the food storage data comprising preferred temperature, humidity, and atmospheric ethylene level for storage of the identified food item; and
indicating with a user interface element of the refrigerator which of the food storage sub-chambers most closely matches the retrieved preferred temperature, humidity, and atmospheric ethylene level for storage of the identified food item, wherein the user interface element comprises a visual indicator and the step of indicating comprises providing a visual indication.

7. The method of claim 6, further comprising modifying the temperature, humidity, and atmospheric ethylene level of one of the at least one food storage sub-chamber having independently controlled temperature, humidity, and atmospheric ethylene level to approximate the preferred temperature, humidity, and atmospheric ethylene level for storage of the identified food item, wherein the step of indicating with a user interface element of the refrigerator which of the food storage sub-chambers most closely matches the retrieved preferred temperature and humidity for storage of the identified food item comprises indicating the food storage sub-chamber having modified temperature, humidity, and atmospheric ethylene level.

8. The method of claim 7, wherein the environmental control system includes an adsorbent for independently controlling the atmospheric ethylene level of the at least one food storage sub-chamber having independently controlled temperature, humidity, and atmospheric ethylene level, the method further comprising modifying the atmospheric ethylene level of one of the at least one food storage sub-chamber having independently controlled temperature, humidity, and atmospheric ethylene level with the adsorbent to approximate the preferred atmospheric ethylene level for storage of the identified food item.

9. The method of claim 6, further comprising recording a location indicator in the inventory log entry associated with the food item which corresponds to the indicated food storage sub-chamber.

10. The method of claim 6, further comprising tracking the volume of food items placed in each storage sub-chamber, and comparing the volume of food items placed in each storage sub-chamber to a maximum storage volume of each food storage sub-chamber.

11. The method of claim 9, wherein the step of indicating comprises indicating which of the food storage sub-chambers most closely matches the retrieved preferred temperature, humidity, and atmospheric ethylene level and has sufficient remaining storage capacity to accommodate the identified food item.

12. A method of tracking and preserving a food inventory in a refrigerator appliance, the refrigerator appliance comprising a controller, a plurality of food storage sub-chambers, at least one of the food storage sub-chambers having independently controlled environmental conditions, and at least one sensor associated with each food storage sub-chamber having independently controlled environmental conditions, the method comprising:
identifying a food item in response to a user input;
adding an entry associated with the food item to an inventory log stored in a memory of the refrigerator controller;
retrieving food storage data related to the identified food item, the food storage data comprising preferred environmental conditions for storage of the identified food item and a safe storage threshold for the identified food item;
modifying the environmental conditions of one of the at least one food storage sub-chamber having independently controlled environmental conditions to approximate the retrieved preferred environmental conditions for storage of the identified food item;
indicating with a user interface element which of the food storage sub-chambers most closely matches the retrieved preferred environmental conditions for storage of the identified food item;
recording the retrieved safe storage threshold in the inventory log entry associated with the food item;
monitoring storage time of the food item;
monitoring storage temperature of the food item over time by monitoring temperature with one of the sensors;
flagging the inventory log entry associated with the food item when the food item approaches the safe storage threshold; and
notifying a user of the flagged food item;
wherein modifying the environmental conditions of one of the food storage sub-chambers having independently controlled environmental conditions comprises modifying the atmospheric ethylene level of the food storage sub-chamber, wherein the user interface element comprises an audible indicator and the step of indicating comprises providing an audible indication.

13. The method of claim 12, further comprising retrieving at least one recipe from a recipe database, the at least one recipe comprising a list of ingredients, the list of ingredients including the flagged food item; generating a shopping list based on the retrieved recipe, the shopping list consisting of all ingredients in the list of ingredients not currently associated with an entry in the stored inventory log; and notifying the user of the recipe and the shopping list.

14. The method of claim 12, wherein the retrieved safe storage threshold for the identified food item comprises a temperature parameter and a time parameter.

15. The method of claim 14 further comprising creating a time-temperature curve for the stored food item and calculating the area under the curve.

16. The method of claim 15, wherein flagging the inventory log entry associated with the food item when the food item approaches the safe storage threshold comprises flagging the inventory log entry associated with the food item when the area under the time-temperature curve approaches the product of the safe storage threshold temperature parameter and the safe storage threshold time parameter.

17. The method of claim 12, wherein the step of monitoring the storage temperature of the food item over time comprises monitoring temperature in the indicated food storage sub-chamber with the at least one sensor associated with the indicated food storage sub-chamber.

18. The method of claim 12, wherein modifying the environmental conditions of one of the food storage sub-chambers having independently controlled environmental conditions further comprises modifying the humidity of the food storage sub-chamber with at least one of a mist pump and a membrane micro-humidifier cell.

19. (canceled)

20. The method of claim 12, wherein modifying the atmospheric ethylene level comprises removing ethylene from the food storage sub-chamber with a filter.

21. The method of claim 7, wherein the environmental control system further includes at least one of a mist pump and a membrane micro-humidifier cell for independently controlling the humidity of the at least one food storage sub-chamber having independently controlled temperature, humidity, and atmospheric ethylene level, the method further comprising modifying the humidity of one of the at least one food storage sub-chamber having independently controlled temperature, humidity, and atmospheric ethylene level with the at least one of the mist pump and the membrane micro-humidifier cell to approximate the preferred humidity for storage of the identified food item.
